(19) United States
(12) Patent Application Publication
(10) Pub. No.: US 2017/0177975 A1
(43) Pub. Date: Jun. 22, 2017

(54) Image quality objective evaluation method based on manifold feature similarity

(71) Applicant: Ningbo University, Ningbo (CN)

(72) Inventors: Mei Yu, Ningbo (CN); Zhaoyun Wang, Ningbo (CN); Zongju Peng, Ningbo (CN); Fen Chen, Ningbo (CN); Yang Song, Ningbo (CN)

(73) Assignee: Ningbo University

(21) Appl. No.: 15/062,112

(22) Filed: Mar. 6, 2016

(30) Foreign Application Priority Data
Dec. 21, 2015 (CN) 201510961907.9

(51) Int. Cl. G06K 9/62; G06K 9/46; G06K 9/52; G06T 7/40

(52) U.S. Cl. CPC G06K 9/6215; G06T 7/408; G06K 9/4652; G06K 9/52; G06K 9/6256; G06K 9/4661; G06T 2207/30168

(57) ABSTRACT

An image quality objective evaluation method based on manifold feature similarity is disclosed, which firstly adopts visual salience and visual threshold to remove image blocks which are unimportant to visual perception, namely, uses roughing selection and fine selection; and then utilizes the best mapping matrix after block selection to extract manifold feature vectors of image blocks which are selected from original undistorted natural scene images and distorted images to be evaluated; and then measures the structural distortion of distorted images according to manifold feature similarity; and then considers effects of image brightness changes on human eyes and obtains the brightness distortion of distorted images based on an average value of image blocks, and finally obtains quality scores according to structural distortion and brightness distortion; which allows the method of the present invention to have a higher evaluation accuracy, and also expands the evaluation capacity to various distortions.

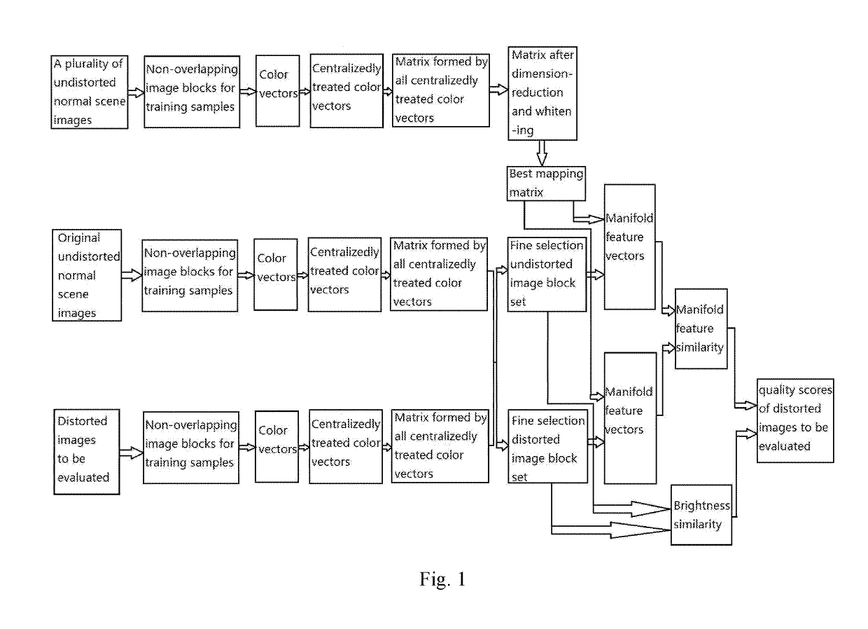

### CROSS REFERENCE OF RELATED APPLICATION

The present invention claims priority under 35 U.S.C. 119(a-d) to CN 201510961907.9, filed Dec. 21, 2015.

### BACKGROUND OF THE PRESENT INVENTION

### Field of Invention

The present invention relates to an image quality evaluation method, and more particularly to an image quality objective evaluation method based on manifold feature similarity.

### Description of Related Arts

The quantitative evaluation of the image quality is a challenging problem in the image processing field. People are final receivers while viewing images, so image quality evaluation method should be able to effectively predict perceive visual quality like people. In spite that the traditional peak signal-to-noise ratio (PSNR) and other image quality evaluation methods based on fidelity criterion are able to better evaluate image qualities with same contents and distortions, evaluation results are far from subjective perception for a plurality of images and a variety of distortions. The objective of perception quality evaluation methods is to obtain evaluation results, having higher consistence with visual perception qualities, by simulating the overall perception mechanism of the human visual system. Physiological responses of the human visual system are modeled for obtaining objective evaluation methods, so as to obtain evaluation results having higher consistence with subjective evaluations. In recent years, researches on image quality evaluations gradually go deeper, people propose many evaluation methods. Compared with PSNR method, the structural similarity (SSIM) algorithm, proposed by Wang et al., is simple and has significant performance improvements, which attracts the attention of scholars. In following work, Wang et al. propose multi-scale structural similarity (MS-SSIM) to improve the performance of SSIM. Some scholars consider that the phase consistence and gradient magnitude are complementary when human eyes evaluate partial images, so that feature similarity (FSIM) is proposed. Except image quality evaluation methods based on structures, some evaluation methods are designed based on other characteristics of the human visual system. Chandler et al. propose the visual signal-to-noise ratio (VSNR), which firstly determines whether distortions are able to be perceived by visual thresholds, and then measures distortions of areas that exceed visual thresholds. Larson et al. think that the human visual system (HVS) adopts various strategies while evaluating high quality images and low quality images, and propose the quality evaluation method of the most apparent distortion (MAD). Sheikh et al. regard the full reference image quality evaluation problem as the information fidelity criterion (IFC) problem, and develop based on the IFC for obtaining the visual information fidelity (VIF) evaluation algorithm. Zhang et al. find that decreased qualities cause image saliency maps to change and are closely related with distortion degrees of perception qualities, thereby proposing image quality evaluation methods based on visual saliency.

Excellent image quality evaluation methods should be able to well reflect human visual reception characteristics. The above image quality evaluation methods based on structures obtain image qualities according to edges, contrast of images and other structural information. However, image quality evaluation methods based on human visual system characteristics are mainly from points of view including human visual attention and distortion perceptive capacity for image quality evaluation. All these image quality evaluation methods evaluate qualities from points of view including nonlinear geometric structures of images and human perception. However, researches show that aiming at visual perception phenomena, manifold is the base of perception, and brains perceive things by a way of manifold. Natural scene images generally contain manifold structures and have the essence of manifold nonlinearity. Therefore, traditional image quality evaluation methods are unable to obtain objective evaluation results having higher consistence with subjective perception qualities.

### SUMMARY OF THE PRESENT INVENTION

A technical problem to be resolved of the present invention is to provide an image quality objective evaluation method based on manifold feature similarity, which is capable of obtaining objective evaluation results having higher consistence with subjective perception qualities.

A technical solution adopted by the present invention for resolving the above technical problem is to provide an image quality objective evaluation method based on manifold feature similarity, comprising steps of:

(1) selecting a plurality of undistorted natural scene images; and then dividing every undistorted natural scene image into non-overlapping image blocks, each of which having a size of 8×8; and then randomly selecting N image blocks from all image blocks of all undistorted natural scene images, taking every selected image block as a training sample, recording a i^{th} training sample as X, wherein 5000≦N≦20000, 1≦i ≦N; and then arranging color values of R, G and B channels of all pixel points in every training sample for forming a color vector, recording the color vector formed by arranging color values of R, G and B channels of all pixel points in Xᵢ as Xᵢ^{col}, wherein a dimension of Xᵢ^{col} is 192×1, values from a 1^{st} element to a 64^{th} element in Xᵢ^{col} are respectively corresponding to color values of the R channel of every pixel point in Xᵢ obtained by a way of progressive scanning, values from a 65^{th} element to a 128^{th} element in Xᵢ^{col} are respectively corresponding to color values of the G channel of every pixel point in Xᵢ obtained by a way of progressive scanning, values from a 129^{th} element to a 192^{nd} element in Xᵢ^{col} are respectively corresponding to color values of the B channel of every pixel point in Xᵢ obtained by a way of progressive scanning; and then subtracting an average value of the values of all elements in a corresponding color vector from a value of every element in the corresponding color vector in every training sample, so as to centralizedly treat the corresponding color vector in every training sample, recording the centralizedly treated color vector in Xᵢ^{col} as \hat{x}ᵢ^{col}; and finally recording a matrix formed by all centralizedly treated color vectors as X, here X=[\hat{x}₁^{col}, \hat{x}₂^{col}, . . . , \hat{x}_{N}^{col}], wherein a dimension of X is 192 ×N, \hat{x}₁^{col}, \hat{x}₁^{col}, . . . , \hat{x}_{N}^{col} respectively represent a centralizedly treated color vector of color values of R, G and B channels of all pixel points in a 1^{st} training sample, a centralizedly treated color vector of color values of R, G and B channels of all pixel points in a 2^{nd} training sample, . . . , and a centralizedly treated color vector of color values of R, G and B channels of all pixel points in a N^{th} training sample, and a symbol “[ ]” is a vector representation symbol;

(2) reducing the dimension of X and whitening X by a principal components analysis (PCA), recording a dimensional reduced and whitened matrix as X^{W}, wherein a dimension of X^{W} is M×N, M is a preset low-dimensional dimension, 1<M<192;

(3) training N column vectors in X^{W} by an existing orthogonal locality preserving projection (OLPP) algorithm for obtaining a best mapping matrix J^{W} of 8 orthogonal bases in X^{W}, wherein a dimension of J^{W} is 8×M; and then calculating a best mapping matrix of the original sample space according to j^{W} and the whitening matrix, recording the best mapping matrix of the original sample space as J, J=J^{W}×W, wherein a dimension of J is 8×192, W represents the whitening matrix, a dimension of W is M×192;

(4) regarding I_{org} as an original undistorted natural scene image, regarding I_{dis} as a distorted image of I_{org}, regarding I_{dis} as a distorted image to be evaluated; and then respectively dividing I_{org} and I_{dis} into non-overlapping image blocks, each of which having a size of 8×8, recording a j^{th} image block in I_{org} as xⱼ^{ref}, recording a j^{th} image block in I_{dis} as xⱼ^{dis} wherein 1≦j≦N′, N′ represents an amount of the image blocks in I_{org}, and also represents an amount of the image blocks in I_{dis}; and then arranging color values of R, G and B channels of all pixel points of every image block in I_{org} for forming a color vector, recording the color vector formed by the color values of the R, G and B channels of all pixel points in xⱼ^{ref} as xⱼ^{ref,col}, arranging color values of R, G and B channels of all pixel points of every image block in I_{dis} for forming a color vector, recording the color vector formed by the color values of the R, G and B channels of all pixel points in xⱼ^{dis} as xⱼ^{dis,col}; wherein a dimension of xⱼ^{ref,col} and xⱼ^{dis,col} is 192×1 values from a 1^{st} element to a 64^{th} element in xⱼ^{ref,col} are respectively corresponding to color values of the R channel of every pixel point in xⱼ^{ref} obtained by a way of progressive scanning, values from a 65^{th} element to a 128^{th} element in xⱼ^{ref,col} are respectively corresponding to color values of the G channel of every pixel point in xⱼ^{ref} obtained by a way of progressive scanning, values from a 129^{th} element to a 192^{nd} element in xⱼ^{ref,col} are respectively corresponding to color values of the B channel of every pixel point in xⱼ^{ref} obtained by a way of progressive scanning; values from a 1^{st} element to a 64^{th} element in xⱼ^{dis,col} are respectively corresponding to color values of the R channel of every pixel point in xⱼ^{dis} obtained by a way of progressive scanning, values from a 65^{th} element to a 128^{th} element in xⱼ^{dis,col} are respectively corresponding to color values of the G channel of every pixel point in xⱼ^{dis} obtained by a way of progressive scanning, values from a 129^{th} element to a 192^{nd} element in xⱼ^{dis,col} are respectively corresponding to color values of the B channel of every pixel point in xⱼ^{dis} obtained by a way of progressive scanning; and then subtracting an average value of the values of all elements in a corresponding color vector from a value of every element in the corresponding color vector of every image block in I_{org}, so as to centralizedly treat the corresponding color vector of every image block in I_{org}, recording the centralizedly treated color vector in xⱼ^{ref,col} as \hat{x}ⱼ^{ref,col}, subtracting an average value of the values of all elements in a corresponding color vector from a value of every element in the corresponding color vector of every image block in I_{dis}, so as to centralizedly treat the corresponding color vector of every image block in I_{dis}, recording the centralizedly treated color vector in xⱼ^{dis,col}; as \hat{x}ⱼ^{dis,col} and finally recording a matrix formed by all centralizedly treated color vectors in I_{org} as X^{ref}, here X^{ref}[\hat{X}₁^{ref,col}, \hat{x}₂^{ref,col}, . . . , \hat{x}_{N}^{ref,col}], recording a matrix formed by all centralizedly treated color vectors in I_{dis}as X^{dis}, here X^{dis}=[\hat{x}₁^{dis,col}, \hat{x}₂^{dis,col}, . . . , \hat{x}_{N}^{dis,col}], wherein a dimension of X^{ref} and X^{dis} is 192×N′, \hat{x}₁^{ref,col}, \hat{x}₂^{ref,col}, . . . , \hat{x}_{N}^{ref,col} respectively represent a centralizedly treated color vector of color values of R, G and B channels of all pixel points of a 1^{st} image block in I_{org}, a centralizedly treated color vector of color values of R, G and B channels of all pixel points in a 2^{nd} image block in I_{org}, . . . , and a centralizedly treated color vector of color values of R, G and B channels of all pixel points in a (N′)^{th} image block in I_{org}; \hat{x}₁^{dis,col}, \hat{x}₂^{dis,col}, . . . , \hat{x}_{N}^{dis,col} respectively represent a centralizedly treated color vector of color values of R, G and B channels of all pixel points of a 1^{st} image block in I_{dis}, a centralizedly treated color vector of color values of R, G and B channels of all pixel points in a 2^{nd} image block in I_{dis}, . . . , and a centralizedly treated color vector of color values of R, G and B channels of all pixel points in a (N′)^{th} image block in I_{dis}; and a symbol “[ ]” is a vector representation symbol;

(5) calculating structural differences between every column vector in X^{ref} and a corresponding column vector in X^{dis}, recording the structural differences between \hat{x}ⱼ^{ref,col} and \hat{x}ⱼ^{dis,col} as AVE(\hat{x}ⱼ^{ref,col}, \hat{x}ⱼ^{dis,col});

and then arranging the obtained N′ structural differences in sequence for forming a vector with a dimension of 1×N′, recording the vector as v, wherein a value of a j^{th} element is vⱼ, here, vⱼ=AVE (\hat{x}ⱼ^{ref,col}, \hat{x}ⱼ^{dis,col});

and then obtaining a roughing selection undistorted image block set and a roughing selection distorted image block set, which specifically comprises steps of: (A) designing an image block roughing selection threshold; (B) extracting elements whose values are larger than or equal to TH₁ from v; and (C) taking a set formed by image blocks corresponding to the extracted elements in I_{org} as the roughing selection undistorted image block set, recording the roughing selection undistorted image block set as Y^{ref}, here, Y^{ref}={xⱼ^{ref}|AVE(\hat{x}ⱼ^{ref,col}, \hat{x}ⱼ^{dis,col})≧TH₁, 1≦j≦N′}; and taking a set formed by image blocks corresponding to the extracted elements in I_{dis} as the roughing selection distorted image block set, recording the roughing selection distorted image block set as Y^{dis}, here, Y^{dis}={xⱼ^{dis}|AVE(\hat{x}ⱼ^{ref,col}, \hat{x}ⱼ^{dis,col})≧TH₁, 1≦j≦N′};

and then obtaining a fine selection undistorted image block set and a fine selection distorted image block set, which specifically comprises steps of: (a) respectively calculating saliency maps of I_{org} and I_{dis} using saliency detection based-on simple priors (SDSP) and recording as f^{ref} and f^{dis}; (b) respectively dividing f^{ref} and f^{dis} into non-overlapping image blocks, each of which having a size of 8×8; (c) calculating an average value of pixel values of all pixel points of every image block in f^{ref}, recording an average value of pixel values of all pixel points of a j^{th} image block in f^{ref} as vsⱼ^{ref}; calculating an average value of pixel values of all pixel points of every image block in f^{dis} a recording an average value of pixel values of all pixel points of a j^{th} image block in f^{dis} as vsⱼ^{dis}, wherein 1≦j≦N′; (d) obtaining a maximum value between the average value of pixel values of all pixel points of every image block in f^{ref} and the average value of pixel values of all pixel points of every image block in f^{dis} recording a maximum value between vsⱼ^{ref} and vsⱼ^{dis} as v_{j,max}, here, vs_{j,max}=max(vsⱼ^{ref}, vsⱼ^{dis}), wherein max( ) is a maximum value function; and (e) finely selecting partial images from the roughing selection undistorted image block set as fine selection undistorted image blocks for forming a fine selection undistorted image block set, recording the fine selection undistorted image block set as Y^{%ref}, here, Y^{%ref}={xⱼ^{ref}|AVE(\hat{x}ⱼ^{ref,col}, \hat{x}ⱼ^{dis,col})≧TH₁ and vs_{j,max}≧TH₂, 1≦j≦N′}; finely selecting partial images from the roughing selection distorted image block set as fine selection distorted image blocks for forming a fine selection distorted image block set, recording the fine selection distorted image block set as U^{%dis}, here, Y^{%dis}={\hat{x}ⱼ^{dis}|AVE(\hat{x}ⱼ^{ref,col}, \hat{x}ⱼ^{dis,col})≧TH₁ and vs_{j,max}≧TH₂, 1≦j≦N′}, wherein TH₂ is a designed image block fine selection threshold;

(6) calculating manifold feature vectors of every image block in the fine selection undistorted image block set, recording a t^{th} manifold feature vector in the fine selection undistorted image block set as rₜ , here, rₜ=J×\hat{x}ₜ^{ref,col}; calculating manifold feature vectors of every image block in the fine selection distorted image block set, recording a t^{th} manifold feature vector in the fine selection distorted image block set as dₜ, here, dₜ=J×\hat{x}ₜ^{dis,col}, wherein 1≦t≦K, K represents an amount of image blocks in the fine selection undistorted image block set and also represents an amount of image blocks in the fine selection distorted image block set, a dimension of rₜ and dₜ is 8×1, \hat{x}^{ref,col} represents a centralizedly treated color vector of color values of R, G and B channels of all pixel points in a t^{th} image block of the fine selection undistorted image block set, and \hat{x}ₜ^{dis,col} represents a centralizedly treated color vector of color values of R, G and B channels of all pixel points in a t^{th} image block of the fine selection distorted image block set;

and then defining manifold feature vectors of all image blocks in the fine selection undistorted image block set as a matrix, recording the matrix as R; defining manifold feature vectors of all image blocks in the fine selection distorted image block set as a matrix, recording the matrix as D, wherein a dimension of R and D is 8×K, a t^{th} column vector in R is rₜ, a t^{th} column vector in D is dₜ;

and then calculating manifold feature similarities of I_{org} and I_{dis}, recording the manifold feature similarities as MFS₁, here,

$${MFS}_{1} = \frac{1}{8 \times K} {\sum }_{m = 1}^{8} {\sum }_{t = 1}^{K} \frac{2 {R}_{m , t} {D}_{m , t} + {C}_{1}}{{( {R}_{m , t} )}^{2} + {( {D}_{m , t} )}^{2} + {C}_{1}} ,$$

wherein R_{m,t} represents a value of M^{th} row and t^{th} column in R, D_{m,t} represents a value of M^{th} row and t^{th} column in D, C₁ is a very small constant for ensuring a result stability;

(7) calculating brightness similarities of I_{org} and I_{dis}, recording the brightness similarities as MFS₂, here,

$${MFS}_{2} = \frac{{\sum }_{t = 1}^{K} ( {μ}_{t}^{ref} - {\overline{μ}}^{ref} ) \times ( {μ}_{t}^{dis} - {\overline{μ}}^{dis} ) + {C}_{2}}{\sqrt{{\sum }_{t = 1}^{K} {( {μ}_{t}^{ref} - {\overline{μ}}^{ref} )}^{2} \times {\sum }_{t = 1}^{K} {( {μ}_{t}^{dis} - {\overline{μ}}^{dis} )}^{2} + {C}_{2}}} ,$$

wherein μₜ^{ref} represents an average value of brightness values of all pixel points in a t^{th} image block in the fine selection undistorted image block set,

$${\overline{μ}}^{ref} = \frac{{\sum }_{t = 1}^{K} {μ}_{t}^{ref}}{K} ;$$

μₜ^{dis} represents an average value of brightness values of all pixel points in a t^{th} image block in the fine selection distorted image block set,

$${\overline{μ}}^{dis} = \frac{{\sum }_{t = 1}^{K} {μ}_{t}^{dis}}{K} ,$$

C₂ is a very small constant; and

(8) linearly weighting MFS₁ and MFS₂ for obtaining mass fractions of I_{dis}, recording the mass fractions as MFS, here, MFS=ω×MFS₂+(1−ω)×MFS₁, wherein ω is adapted for adjusting a relative importance of MFS₁ and MFS₂, 0<ω<1.

In the step (2), an acquisition method of r comprises steps of:

(2A) calculating a covariance matrix of X and recording the covariance matrix as C,

$$C = \frac{1}{N} ( X \times {X}^{T} ) ,$$

wherein a dimension of C is 192×192, X^{T} is a transposed matrix of X;

(2B) eigenvalue-decomposing C based on prior art for obtaining an eigenvalue diagonal matrix and an eigenvector matrix, respectively recording the eigenvalue diagonal matrix and the eigenvector matrix as ψ and E, wherein a dimension of ψ is 192×192,

$$ψ = [ \begin{matrix}{ψ}_{1} & 0 & … & 0 \\ 0 & {ψ}_{2} & … & 0 \\ M & M & M & M \\ 0 & 0 & … & {ψ}_{192}\end{matrix} ] ,$$

ψ₁, ψ₂ and ψ₁₉₂ respectively represent a 1^{st} eigenvalue, a 2nd eigenvalue and a 192^{nd} eigenvalue after decomposition, a dimension of E is 192×192, E=[e₁ e₂ . . . e₁₉₂], e₁, e₂ and e₁₉₂ respectively represent a 1^{st} eigenvector, a 2^{nd} eigenvector and a 192^{nd} eigenvector after decomposition, a dimension of e₁, e₂ and e₁₉₂ is 192×1;

(2C) calculating a whitening matrix and recording the whitening matrix as W, W=ψ_{M×192}^{-1/2}×E^{T}, wherein a dimension of W is M×192,

$${ψ}_{M \times 192}^{- \frac{1}{2}} = [ \begin{matrix}1 / \sqrt{{ψ}_{1}} & 0 & … & 0 & … & 0 \\ 0 & 1 / \sqrt{{ψ}_{2}} & … & 0 & … & 0 \\ M & M & M & M & M & M \\ 0 & 0 & … & 1 / \sqrt{{ψ}_{M}} & … & 0\end{matrix} ] ,$$

ψ_{M} represents a M^{th} eigenvalue after decomposition, M is a preset low-dimensional dimension, 1<M<192, E^{T} is a transposed matrix of E; and

(2D) calculating the dimension-reduced and whitened matrix r, wherein X^{W}, wherein X^{W} W×X.

In the step (5),

$$AVE ( {\hat{x}}_{j}^{ref , col} , {\hat{x}}_{j}^{dis , col} ) = \vert {\sum }_{g = 1}^{192} {( {\hat{x}}_{j}^{ref , col} ( g ) )}^{2} - {\sum }_{g = 1}^{192} {( {\hat{x}}_{j}^{dis , col} ( g ) )}^{2} \vert ,$$

here, a symbol “∥” is an absolute value symbol, \hat{x}ⱼ^{ref,col}(g) represents a value of a g^{th} element in \hat{x}ⱼ^{ref,col}, \hat{x}ⱼ^{dis,col}(g) represents a value of a g^{th} element in \hat{x}ⱼ^{dis,col}.

In the step (A) of the step (5), TH₁=median(v) , here, median ( ) is a median selection function, median(v) represents selecting a mid-value of values of all elements in v.

In the step (e) of the step (5), a value of TH₂ is a maximum value at a former 60% position after arranging all maximum values obtained in the step (d) from big to small.

Compared with the prior art, advantages of the present invention are as follows.

(1) Based on human eye perception by a way of manifold, the present invention uses the orthogonal locality preserving projection (OLPP) algorithm to obtain dimension-reduced and whitened matrixes from natural scene images for training, so as to obtain a generally best mapping matrix. To improve evaluation accuracy and stability, the present invention firstly adopts visual salience and visual threshold to remove image blocks which are unimportant to visual perception, namely, uses roughing selection and fine selection; and then utilizes the best mapping matrix after block selection to extract manifold feature vectors of image blocks which are selected from original undistorted natural scene images and distorted images to be evaluated; and then measures the structural distortion of distorted images according to manifold feature similarity; and then considers effects of image brightness changes on human eyes and obtains the brightness distortion of distorted images based on an average value of image blocks, which allows the method of the present invention to have a higher evaluation accuracy, also expands the evaluation capacity to various distortions, is capable of objectively reflecting changes of the image visual quality under the influence of various image processing and compression methods. The evaluation performance of the method of the present invention is not affected by image contents and distortion types. The present invention has higher consistence with subjective perception qualities of human eyes.

(2) The evaluation performance of the method of the present invention is little affected by various image libraries. Performance results obtained from various training libraries are basically same. Therefore, the best mapping matrix in the method of the present invention is a general manifold feature extractor. Once obtained by the orthogonal locality preserving projection (OLPP) algorithm, the best mapping matrix is able to be used for the quality evaluation of all images without time-consuming training processes during every evaluation. Furthermore, images for training and images for testing are independent from each, so that the over reliance of testing results on training data is avoided, thereby effectively improving the correlation between objective evaluation results and subjective perception qualities.

These and other objectives, features, and advantages of the present invention will become apparent from the following detailed description, the accompanying drawings, and the appended claims.

### BRIEF DESCRIPTION OF THE DRAWINGS

The drawing is an overall implementation block diagram of an image quality objective evaluation method based on manifold feature similarity of the present invention.

### DETAILED DESCRIPTION OF THE PREFERRED EMBODIMENT

The present invention is further described in detail accompanying with drawings and embodiments.

An excellent image quality elevation method should well reflect human visual perception characteristics. For visual perception phenomena, studies show that the manifold is the basis of perception, human perception is based on cognitive manifold and topology continuity, namely, human perception is limited to low-dimensional manifolds, and the brain perceives things by a way of manifold. In general, neuronal group activities in the brain are able to be described as an aggregate result of neural discharge rates, and therefore they are able to be represented by a point in the abstract space with a dimension equal to the number of neurons. Studies found that the discharge rate of every neuron in a neuronal population is able to be represented by a smoothing function of few variables, which shows that neuronal group activities are limited to low-dimensional manifolds. Therefore, image manifold characteristics are applied to the visual quality evaluation for obtaining evaluation results having higher consistency with the subjectively perceptive quality. However, manifold learning is able to better help to find intrinsic geometric structures of images in low-dimensional manifolds for representing the nonlinear manifold essence of things.

According to human visual characteristics perceived by a way of manifold and the manifold learning theory, the present invention provides an image quality objective evaluation method based on manifold feature similarity (MFS). During the training stage, MFS utilizes the manifold learning orthogonal locality preserving projection algorithm to obtain the best mapping matrix for extracting manifold features of images. During the quality prediction stage, undistorted natural scene images and distorted images are divided into image blocks, and then the mean value of every image block is removed such that color vectors corresponding to all image blocks have zero-mean, and then the MFS is calculated based on the previous condition. However, the average value of all image blocks is used to calculate the luminance similarity. Here, the MFS represents the structural difference between two images, and the luminance similarity measures the brightness distortion of distorted images. Finally, the two similarities are balanced for obtaining the overall visual quality of distorted images.

The drawing is an overall implementation block diagram of an image quality objective evaluation method based on manifold feature similarity of the present invention. The image quality objective evaluation method comprises steps of:

(1) selecting a plurality of undistorted natural scene images; and then dividing every undistorted natural scene image into non-overlapping image blocks, each of which having a size of 8×8; and then randomly selecting N image blocks from all image blocks of all undistorted natural scene images, taking every selected image block as a training sample, recording a i^{t h} training sample as Xᵢ, wherein 5000≦N≦20000, 1≦i≦N; and then arranging color values of R, G and B channels of all pixel points in every training sample for forming a color vector, recording a color vector formed by arranging color values of R, G and B channels of all pixel points in Xᵢ as Xᵢ^{col}, wherein a dimension of Xₜ^{col} is 192×1, values from a 1^{st} element to a 64^{th} element in Xᵢ^{col} are respectively corresponding to color values of the R channel of every pixel point in Xᵢ obtained by a way of progressive scanning, that is to say, that a value of the 1^{st} element in Xᵢ^{col} is corresponding to a color value of a R channel of a pixel point at 1^{st} row, 1^{st} column in Xᵢ, a value of a 2^{nd} element in Xᵢ^{col} is corresponding to a color value of a R channel of a pixel point at 1^{st} row, 2^{nd} column in Xᵢ and so on; values from a 65^{th} element to a 128^{th} element in Xᵢ^{col} are respectively corresponding to color values of the G channel of every pixel point in Xᵢ obtained by a way of progressive scanning, that is to say, that a value of the 65^{th} element in Xᵢ^{col} is corresponding to a color value of a G channel of a pixel point at 1^{st} row, 1^{st} column in Xᵢ, a value of a 66^{th} element in Xᵢ^{col} is corresponding to a color value of a G channel of a pixel point at 1^{st} row, 2^{nd} column in Xᵢ and so on; values from a 129^{th} element to a 192^{nd} element in Xᵢ^{col} are respectively corresponding to color values of the B channel of every pixel point in Xᵢ obtained by a way of progressive scanning, that is to say, that a value of the 129^{th} element in Xᵢ^{col} is corresponding to a color value of a B channel of a pixel point at 1^{st} row, 1^{st} column in Xᵢ, a value of a 130^{th} element in Xᵢ^{col} is corresponding to a color value of a B channel of a pixel point at 1^{st} row, 2^{nd} column in Xᵢ and so on; and then subtracting an average value of the values of all elements in a corresponding color vector from a value of every element in the corresponding color vector in every training sample, so as to centralizedly treat the corresponding color vector in every training sample, recording the centralizedly treated color vector in X₁^{col} as \hat{x}ᵢ^{col}, wherein a value of every element in \hat{x}ᵢ^{col} is that a value of an element at a corresponding position in xᵢ^{col} minus an average value of values of all elements in xᵢ^{col} and finally recording a matrix formed by all centralizedly treated color vectors as X, here X=[\hat{x}₁^{col}, \hat{x}₂^{col}, . . . , \hat{x}_{N}^{col} ], wherein a dimension of X is 192×N, \hat{x}₁^{col}, \hat{x}₂^{col}, . . . , \hat{x}_{N}^{col} respectively represent a centralizedly treated color vector of color values of R, G and B channels of all pixel points in a 1^{st} training sample, a centralizedly treated color vector of color values of R, G and B channels of all pixel points in a 2^{nd} training sample, . . . , and a centralizedly treated color vector of color values of R, G and B channels of all pixel points in a N^{th} training sample, and a symbol “[ ]” is a vector representation symbol;

herein, sizes of the plurality of undistorted natural scene images are all the same, or different from each other, or part of the same; while specifically implementing, ten undistorted natural scene images are selected; a value range of N is determined through a lot of experiments, if a value of N is too small (such as smaller than 5000), namely, an amount of the image blocks is fewer, a training accuracy will be greatly affected, if a value of N is too big (such as bigger than 20000), namely, the amount of the image blocks is more, the training accuracy will be improved less, but a computational complexity will be increased more, and therefore, the value range of N is limited to 5000≦N≦20000, while specifically implementing, N=20000; due to R, G and B channels of a color image, a color vector of every training sample has a length of 8×8×3=192;

(2) reducing the dimension of X and whitening X by a principal components analysis (PCA), recording a dimensional reduced and whitened matrix as X^{W}, wherein a dimension of X^{W} is M×N, M is a preset low-dimensional dimension, 1<M<192, in this embodiment, M=8; wherein an acquisition method of X^{W} comprises steps of:

(2A) calculating a covariance matrix of X and recording the covariance matrix as C,

$$C = \frac{1}{N} ( X \times {X}^{T} ) ,$$

wherein a dimension of C is 192×192, X^{T} is a transposed matrix of X;

(2B) eigenvalue-decomposing C based on prior art for obtaining an eigenvalue diagonal matrix and an eigenvector matrix, respectively recording the eigenvalue diagonal matrix and the eigenvector matrix as ψ and E, wherein a dimension of ψ is 192×192,

$$ψ = [ \begin{matrix}{ψ}_{1} & 0 & … & 0 \\ 0 & {ψ}_{2} & … & 0 \\ M & M & M & M \\ 0 & 0 & … & {ψ}_{192}\end{matrix} ] ,$$

ψ₁, ψ₂ and ψ₁₉₂ respectively represent a 1^{st} eigenvalue, a 2^{nd} eigenvalue and a 192^{nd} eigenvalue after decomposition, a dimension of E is 192×192, E=[e₁ e₂ . . . e₁₉₂], e₁, e₂ and e₁₉₂ respectively represent a 1^{st} eigenvector, a 2^{nd} eigenvector and a 192^{nd} eigenvector after decomposition, a dimension of e₁, e₂ and e₁₉₂ is 192×1;

(2C) calculating a whitening matrix and recording the whitening matrix as W, W=ψ_{M×192}^{-1/2}×E^{T}, wherein a dimension of W is M×192,

$${ψ}_{M \times 192}^{- \frac{1}{2}} = [ \begin{matrix}1 / \sqrt{{ψ}_{1}} & 0 & … & 0 & … & 0 \\ 0 & 1 / \sqrt{{ψ}_{2}} & … & 0 & … & 0 \\ M & M & M & M & M & M \\ 0 & 0 & … & 1 / \sqrt{{ψ}_{M}} & … & 0\end{matrix} ] ,$$

ψ_{M} represents a M^{th} eigenvalue after decomposition, ψ_{M×192} is a matrix formed by a former M rows in ψ, namely,

$${ψ}_{M \times 192} = [ \begin{matrix}{ψ}_{1} & 0 & … & 0 & … & 0 \\ 0 & {ψ}_{2} & … & 0 & … & 0 \\ M & M & M & M & M & M \\ 0 & 0 & … & {ψ}_{M} & … & 0\end{matrix} ] ,$$

M is a preset low-dimensional dimension, 1<M<192, in this embodiment, M=8; in the experiment, the former 8 rows in ψ (ψ_{M×192}^{-1/2}), namely, the former 8 principal components are adapted for training, that is to say, the dimension of X after reducing the dimension and whitening is reduced from 192 to 8, E^{T} is a transposed matrix of E; and

(2D) calculating the dimension-reduced and whitened matrix X^{W} wherein X^{W}=W×X;

(3) training N column vectors in X^{W} by an existing orthogonal locality preserving projection (OLPP) algorithm for obtaining a best mapping matrix J^{W} of 8 orthogonal bases in X^{W}, wherein a dimension of J^{W} is 8×M; after learning, transforming the best mapping matrix back from a whitening sample space to an original sample space; and then calculating a best mapping matrix of the original sample space according to J^{W} and the whitening matrix, recording the best mapping matrix of the original sample space as J, J=J^{W}×W, wherein a dimension of J is 8×192, W represents the whitening matrix, a dimension of W is M×192; in this present invention, J is regarded as a model perceived via a brain by a way of manifold and is adopted for extracting manifold features of image blocks;

(4) regarding I_{org} as an original undistorted natural scene image, regarding I_{dis} as a distorted image of I_{org}, regarding I_{dis} as a distorted image to be evaluated; and then respectively dividing I_{org} and I_{dis} into non-overlapping image blocks, each of which having a size of 8 ×8, recording a j^{th} image block in I_{org} as xⱼ^{ref} , recording a j^{th} image block in I_{dis} as xⱼ^{dis}, wherein 1≦j≦N′, N′ represents an amount of the image blocks in I_{org}, and also represents an amount of the image blocks in I_{dis}; and then arranging color values of R, G and B channels of all pixel points of every image block in I_{org} for forming a color vector, recording the color vector formed by the color values of the R, G and B channels of all pixel points in xⱼ^{ref} as xⱼ^{ref,col}, arranging color values of R, G and B channels of all pixel points of every image block in I_{dis} for forming a color vector, recording the color vector formed by the color values of the R, G and B channels of all pixel points in xⱼ^{dis} as xⱼ^{dis,col}, wherein a dimension of xⱼ^{ref,col} and xⱼ^{dis,col} is 192×1, values from a 1^{st} element to a 64^{th} element in xⱼ^{ref,col} are respectively corresponding to color values of the R channel of every pixel point in xⱼ^{ref} obtained by a way of progressive scanning, values from a 65^{th} element to a 128^{th} element in xⱼ^{ref,col} are respectively corresponding to color values of the G channel of every pixel point in xⱼ^{ref} obtained by a way of progressive scanning, values from a 129^{th} element to a 192^{nd} element in xⱼ^{ref,col} are respectively corresponding to color values of the B channel of every pixel point in xⱼ^{ref} obtained by a way of progressive scanning; values from a 1^{st} element to a 64^{th} element in xⱼ^{dis,col} are respectively corresponding to color values of the R channel of every pixel point in xⱼ^{dis} obtained by a way of progressive scanning, values from a 65^{th} element to a 128^{th} element in xⱼ^{dis,col} are respectively corresponding to color values of the G channel of every pixel point in xⱼ^{dis} obtained by a way of progressive scanning, values from a 129^{th} element to a 192^{nd} element in xⱼ^{dis,col} are respectively corresponding to color values of the B channel of every pixel point in xⱼ^{dis} obtained by a way of progressive scanning; and then subtracting an average value of the values of all elements in a corresponding color vector from a value of every element in the corresponding color vector of every image block in I_{g}, so as to centralizedly treat the corresponding color vector of every image block in I_{org}, recording the centralizedly treated color vector in xⱼ^{ref,col} as \hat{x}ⱼ^{ref,col}, subtracting an average value of the values of all elements in a corresponding color vector from a value of every element in the corresponding color vector of every image block in I_{dis}, so as to centralizedly treat the corresponding color vector of every image block in I_{dis}, recording the centralizedly treated color vector in xⱼ^{dis,col} as \hat{x}ⱼ^{dis,col}; and finally recording a matrix formed by all centralizedly treated color vectors in I_{org} as X^{ref} , here X^{ref}=[\hat{x}₁^{ref,col}, \hat{x}₂^{ref,col}, . . . , \hat{x}_{N′}^{ref,col}], recording a matrix formed by all centralizedly treated color vectors in I_{dis} as X^{dis}, here X^{dis}=[\hat{x}₁^{dis,col}, \hat{x}₂^{dis,col}, . . . , \hat{x}_{N′}^{dis,col}], wherein a dimension of X^{ref} and X^{dis} is 192×N′, \hat{x}₁^{ref,col}, \hat{x}₂^{ref,col}, . . . , \hat{x}_{N′}^{ref,col} respectively represent a centralizedly treated color vector of color values of R, G and B channels of all pixel points of a 1^{st} image block in I_{org}, a centralizedly treated color vector of color values of R, G and B channels of all pixel points in a 2^{nd} image block in I_{org}, . . . , and a centralizedly treated color vector of color values of R, G and B channels of all pixel points in a (N′)^{th} image block in I_{org}; \hat{x}₁^{dis,col}, \hat{x}₂^{dis,col}, . . . , \hat{x}_{N′}^{dis,col} respectively represent a centralizedly treated color vector of color values of R, G and B channels of all pixel points of a 1^{st} image block in I_{dis}, a centralizedly treated color vector of color values of R, G and B channels of all pixel points in a 2^{nd} image block in I_{dis}, . . . , and a centralizedly treated color vector of color values of R, G and B channels of all pixel points in a (N′)^{th} image block in I_{dis}; and a symbol “[ ]” is a vector representation symbol;

(5) obtaining a block after the value of every element in the color vector corresponding to every image block minus the average value; due to the block contains contrast and structure information, regarding the block as a structural block; calculating structural differences between every column vector in X^{ref} and a corresponding column vector in X^{dis} by an absolute variance error (AVE), recording the structural differences between \hat{x}ⱼ^{ref,col} and \hat{x}ⱼ^{dis,col} as AVE(\hat{x}ⱼ^{ref,col}, \hat{x}ⱼ^{dis,col}), here,

$$AVE ( {\hat{x}}_{j}^{ref , col} , {\hat{x}}_{j}^{dis , col} ) = \vert {\sum }_{g = 1}^{192} {( {\hat{x}}_{j}^{ref , col} ( g ) )}^{2} - {\sum }_{g = 1}^{192} {( {\hat{x}}_{j}^{dis , col} ( g ) )}^{2} \vert ,$$

wherein a symbol “| |” is an absolute value symbol, \hat{x}ⱼ^{ref,col}(g) represents a value of a g^{th} element in \hat{x}ⱼ^{ref,col}, \hat{x}ⱼ^{dis,col}(g) represents a value of a g^{th} element in \hat{x}ⱼ^{dis,col};

and then arranging the obtained N′ structural differences in sequence for forming a vector with a dimension of 1×N′, recording the vector as v, wherein a value of a j^{th} element is vⱼ, vⱼ=AVE (\hat{x}ⱼ^{ref,col}, \hat{x}ⱼ^{dis,col});

and then obtaining a roughing selection undistorted image block set and a roughing selection distorted image block set, which specifically comprises steps of: (A) designing an image block roughing selection threshold TH₁, here, TH₁=median(v), wheriein median( ) is a median selection function, median(v) represents selecting a mid-value of values of all elements in v; (B) extracting elements whose values are larger than or equal to TH₁ from v; and (C) taking a set formed by image blocks corresponding to the extracted elements in I_{org} as the roughing selection undistorted image block set, recording the roughing selection undistorted image block set as Y^{ref}, here, Y^{ref}={ⱼ^{ref}|AVE(\hat{x}ⱼ^{ref,col}, \hat{x}ⱼ^{dis,col})≧TH₁, 1≦j≦N′}; and taking a set formed by image blocks corresponding to the extracted elements in I_{dis} as the roughing selection distorted image block set, recording the roughing selection distorted image block set as Y^{dis}, here, Y^{dis}={xⱼ^{dis}|AVE(\hat{x}ⱼ^{ref,col}, \hat{x}ⱼ^{dis,col})≧TH₁, 1≦j≦N′};

wherein for using structural differences to select blocks, only areas with large structural differences are considered, these areas are generally corresponding to areas with low quality in distorted image but not necessary areas about which people are concerned most, and therefore fine selection is needed, namely, a fine selection undistorted image block set and a fine selection distorted image block set are obtained again, which specifically comprises steps of: (a) respectively calculating saliency maps of I_{org} and I_{dis} using saliency detection based-on simple priors (SDSP) and recording as f^{ref} and f^{dis}; (b) respectively dividing f^{ref} and f^{dis} into non-overlapping image blocks, each of which having a size of 8×8; (c) calculating an average value of pixel values of all pixel points of every image block in f^{ref}, recording an average value of pixel values of all pixel points of a j^{th} image block in f^{ref} as vsⱼ^{ref}; calculating an average value of pixel values of all pixel points of every image block in f ^{dis} recording an average value of pixel values of all pixel points of a j^{th} image block in f ^{dis} as vsⱼ^{dis}, wherein 1≦j≦N′; (d) obtaining a maximum value between the average value of pixel values of all pixel points of every image block in f^{ref} and the average value of pixel values of all pixel points of every image block in f^{dis}, recording a maximum value between vsⱼ^{ref} and vsⱼ^{dis} as vs_{j,max}, here, vs_{j,max}=max(vsⱼ^{ref}, vsⱼ^{dis}), wherein max( ) is a maximum value function, the average value of pixel values of all pixel points of every image block is able to represent a visual importance of the image block, an image block with higher average value in f^{ref} and f^{dis} has a larger effect while evaluating a similarity of a saliency map where the image block is located; and (e) finely selecting partial images from the roughing selection undistorted image block set as fine selection undistorted image blocks for forming a fine selection undistorted image block set, recording the fine selection undistorted image block set as Y^{%ref}, here, Y^{%ref}={xⱼ^{ref}|AVE(\hat{x}ⱼ^{ref,col}, \hat{x}ⱼ^{dis,col})≧TH₁ and vs_{j,max}≧TH₂, 1≦j≦N′}; finely selecting partial images from the roughing selection distorted image block set as fine selection distorted image blocks for forming a fine selection distorted image block set, recording the fine selection distorted image block set as Y^{%dis}, here, Y^{%dis}={xⱼ^{dis}|AVE(\hat{x}ⱼ^{ref,col}, \hat{x}ⱼ^{dis,col}), ≧TH₁ and vs_{j,max}≧TH₂, 1≦j≦N′}, wherein TH₂ is a designed image block fine selection threshold, a value of TH₂ is a maximum value at a former 60% position after arranging all maximum values obtained in step (d) from big to small;

(6) calculating manifold feature vectors of every image block in the fine selection undistorted image block set, recording a t^{th} manifold feature vector in the fine selection undistorted image block set as rₜ, here, rₜ=J×\hat{x}ₜ^{ref,col}; calculating manifold feature vectors of every image block in the fine selection distorted image block set, recording a t^{th} manifold feature vector in the fine selection distorted image block set as dₜ, here, dₜ=J×\hat{x}ₜ^{dis,col}, wherein 1≦t≦K , K represents an amount of image blocks in the fine selection undistorted image block set and also represents an amount of image blocks in the fine selection distorted image block set, a dimension of rₜ and dₜ is 8×1, \hat{x}ₜ^{ref, col} represents a centralizedly treated color vector of color values of R, G and B channels of all pixel points in a t^{th} image block of the fine selection undistorted image block set, and \hat{x}ₜ^{dis,col} represents a centralizedly treated color vector of color values of R, G and B channels of all pixel points in a t^{th} image block of the fine selection distorted image block set;

and then defining manifold feature vectors of all image blocks in the fine selection undistorted image block set as a matrix, recording the matrix as R; defining manifold feature vectors of all image blocks in the fine selection distorted image block set as a matrix, recording the matrix as D, wherein a dimension of R and D is 8×K , a t^{th} column vector in R is rₜ , a t^{th} column vector in D is dₜ;

and then calculating manifold feature similarities of I_{org} and I_{dis} recording the manifold feature similarities as MFS₁, here,

$${MFS}_{1} = \frac{1}{8 \times K} {\sum }_{m = 1}^{8} {\sum }_{t = 1}^{K} \frac{2 {R}_{m , t} {D}_{m , t} + {C}_{1}}{{( {R}_{m , t} )}^{2} + {( {D}_{m , t} )}^{2} + {C}_{1}} ,$$

wherein R_{m,t} represents a value of M^{th} row and t^{th} column in R, D_{m,t} represents a value of M^{th} row and t^{th} column in D, C₁ is a very small constant for ensuring a result stability, in this embodiment, C₁=0.09;

(7) calculating brightness similarities of I_{org}, and I_{dis}, recording the brightness similarities as MFS₂, here,

$${MFS}_{2} = \frac{{\sum }_{t = 1}^{K} ( {μ}_{t}^{ref} - {\overline{μ}}^{ref} ) \times ( {μ}_{t}^{dis} - {\overline{μ}}^{dis} ) + {C}_{2}}{\sqrt{{\sum }_{t = 1}^{K} {( {μ}_{t}^{ref} - {\overline{μ}}^{ref} )}^{2} \times {\sum }_{t = 1}^{K} {( {μ}_{t}^{dis} - {\overline{μ}}^{dis} )}^{2} + {C}_{2 }}} ,$$

wherein μₜ^{ref} represents an average value of brightness values of all pixel points in a t^{th} image block in the fine selection undistorted image block set,

$${\overline{μ}}^{ref} = \frac{{\sum }_{t = 1}^{K} {μ}_{t}^{ref}}{K} ;$$

μₜ^{dis} represents an average value of brightness values of all pixel points in a t^{th} image block in the fine selection distorted image block set,

$${\overline{μ}}^{dis} = \frac{{\sum }_{t = 1}^{K} {μ}_{t}^{dis}}{K} ,$$

C₂ is a very small constant, in this embodiment, C₂=0.001; and

(8) linearly weighting MFS₁ and MFS₂ for obtaining mass fractions of I_{dis}, recording the mass fractions as MFS, here, MFS=ω×MFS₂+(1−ω)×MFS₁, wherein ω is adapted for adjusting a relative importance of MFS₁ and MFS₂, 0<ω<1, in this embodiment, ω=0.8.

To further show the feasibility and effectiveness of the present invention, experiments are done aiming at the method disclosed by the present invention.

Experiment 1: Verify Performance Indexes of the Method Disclosed by the Present Invention

To verify the effectiveness of manifold feature similarity (MFS), the method disclosed by the present invention is tested on four public test image libraries, and evaluation results are simultaneously compared with each other. The four public test image libraries for testing are respectively LIVE test image library, CSIQ test image library, TID2008 test image library and TID2013 test image library. Every test image library contains thousands of distorted images, and simultaneously owns a variety of distortion types. A subjective score, such as a mean opinion score (MOS) or a differential mean opinion score (DMOS), is given to every distorted image. Table 1 shows an amount of reference images, an amount of distorted images, and an amount of distortion types of every test image library, and an amount of people involved in subjective experiments. During experiments, only distorted images are evaluated and original images are removed. Final performance verification of the present invention is made based on the comparison between subjective scores and objective evaluation results.

TABLE 1
Four test image libraries applied
to image quality evaluation method

| | | | | Amount of |
|---|---|---|---|---|
| | Amount of | Amount of | Amount of | people involved |
| Test image | reference | distorted | distortion | in subjective |
| library | images | images | types | experiments |
| TID2013 | 25 | 3000 | 25 | 971 |
| TID2008 | 25 | 1700 | 17 | 838 |
| CSIQ | 30 | 866 | 6 | 35 |
| LIVE | 29 | 779 | 5 | 161 |

According to the standard verification method provided by video quality evaluation expert group Phasel/II(VQEG), four general evaluation indexes are adopted to obtain evaluation performances of image quality evaluation methods. Spearman rand-order correlation coefficient (SROCC) and Kendall rank-order correlation coefficient (KROCC) are adapted for evaluating pros and cons of prediction montonicity of image quality evaluation methods. These two indexes are made on sorted data and relative distances between data points. To obtain other two indexes, namely Pearson linear correlation coefficient (PLCC) and Root mean squared error (RMSE), it is needed for objective evaluation values and mean opinion scores (MOS) to making the nonlinear mapping, so as to remove nonlinear effects of objective scores. Five-parameter nonlinear mapping function

$$Q ( q ) = {α}_{1} ( \frac{1}{2} - \frac{1}{1 + exp ( {α}_{2} ( q - {α}_{3} ) )} ) + {α}_{4} q + {α}_{5}$$

is adopted to making the nonlinear fitting, wherein q represents an original objective quality evaluation score, Q represents a nonlinearly mapped score, five adjusting parameters α₁, α₂, α₃, α₄ and α₅ are determined by variance sums between objective scores after minimum mapping and opinion scores, exp( ) is an exponential function taking a natural base e as a base. PLCC, SROCC and KROCC are higher, RMSE are lower, which is able to show that the correlation between mean opinion scores and evaluation results of the method disclosed by the present invention is better.

In the method disclosed by the present invention, representative ten image quality evaluation methods, which are respectively SSIM, MS-SSIM, IFC, VIF, VSNR, MAD, GSM, RFSIM, FSIMc and VSI, are compared with each other.

In this embodiment, 10 undistorted images in the TOY image data library are adopted, 20000 image blocks are randomly selected for training to obtain the best mapping matrix J, and then the best mapping matrix J is adopted for subsequent image quality evaluation. Table 2 shows four prediction performance indexes, which are respectively SROCC, KROCC, PLCC and RMSE, on four test image libraries of every image quality evaluation method. In Table 2, indexes of two image quality evaluation methods with the best index performance in all image quality evaluation methods are labeled as blackbody. It can be seen from Table 2 that performances of the method disclosed by the present invention on all test image libraries are good. Firstly, on the CSIQ test image library, the performance is the best and better than other all image quality evaluation methods. Secondly, compared with other all image quality evaluation methods, the method disclosed by the present invention has better performance on the two largest image libraries TID2008 and TID2013 than other algorithm and has approximate performance with the VSI algorithm. In spite that the performance of the present invention on the LIVE test image library is not the best, the difference between the performance of the present invention and the evaluation performance of the best image quality evaluation method is slight. In contrast, the existing image quality evaluation method may have good effects on some test image libraries, but have passable effects on other test image libraries. For example, the VIF algorithm and the MAD algorithm have better evaluation effects on the LIVE test image library, but bad evaluation effects on the TID2008 test image library and the TID2013 test image library. Therefore, as a whole, compared with existing image quality evaluation methods, quality prediction results are more close to subjective elevations of the method disclosed by the present invention.

To more comprehensively evaluate the capacity of every image quality evaluation method predicting image quality reduction caused by special distortions, evaluation performances of the method disclosed by the present invention and existing image quality evaluation methods under special distortions are tested. SROCC is adopted for conditions with fewer data points and is not affected by nonlinear mapping, so SROCC is selected as the performance index. Of course, other performance indexes such as KROCC, PLCC and RMSE are able to draw similar conclusions. In Table 3, three image quality evaluation methods with three former SROCC values in every distortion type of every test image library are labeled as blackbody. It can be seen from Table 3 that there are 31 times for the VSI algorithm to be located at the former three, there are 25 times for the method disclosed by the present invention to be located at the former three, and then followed by the FSIMc algorithm and the GSM algorithm. Therefore, the conclusion is able to be drawn that under special distortion types, the VSI algorithm is the best, and then followed by the method disclosed by the present invention, the FSIMc algorithm and the GSM algorithm in sequence. The most important is that the VSI algorithm, the MFS algorithm, the FSIMc algorithm and the GSM algorithm are better than other methods. Furthermore, on the two largest test image libraries TID2008 and TID2013, the method disclosed by the present invention has better evaluation performances for AGN, SCN, MN, HFN, IN, JP2K and J2TE distortions than existing image quality evaluation methods, and has best evaluation performances for AGWN and GB distortions on the LIVE and CSIQ test image libraries.

TABLE 2
Overall performance contrasts of 11 image quality evaluation methods on 4 test image libraries

| Test image | | | MS- | | | | | | | | | |
|---|---|---|---|---|---|---|---|---|---|---|---|---|
| library | | SSIM | SSIM | IFC | VIF | VSNR | MAD | GSM | RFSM | FSIMc | VSI | MFS |
| TID | SROC | 0.7471 | 0.7859 | 0.5389 | 0.6769 | 0.6812 | 0.7808 | 0.7946 | 0.7744 | 0.8510 | 0.8965 | 0.8741 |
| 2013 | KROC | 0.5588 | 0.6407 | 0.3939 | 0.5147 | 0.5084 | 0.6035 | 0.6255 | 0.5951 | 0.6665 | 0.7183 | 0.6862 |
| | PLCC | 0.7895 | 0.8329 | 0.5538 | 0.7720 | 0.7402 | 0.8267 | 0.8464 | 0.8333 | 0.8769 | 0.9000 | 0.8856 |
| | RMSE | 0.7608 | 0.6861 | 1.0322 | 0.7880 | 0.8392 | 0.6975 | 0.6603 | 0.6852 | 0.5959 | 0.5404 | 0.5757 |
| TID | SROC | 0.7749 | 0.8542 | 0.5675 | 0.7491 | 0.7046 | 0.8340 | 0.8504 | 0.8680 | 0.8840 | 0.8979 | 0.8893 |
| 2008 | KROC | 0.5768 | 0.6568 | 0.4236 | 0.5860 | 0.5340 | 0.6445 | 0.6596 | 0.6780 | 0.6991 | 0.7123 | 0.7055 |
| | PLCC | 0.7732 | 0.8451 | 0.7340 | 0.8084 | 0.6820 | 0.8308 | 0.8422 | 0.8645 | 0.8762 | 0.8762 | 0.8865 |
| | RMSE | 0.8511 | 0.7173 | 0.9113 | 0.7899 | 0.9815 | 0.7468 | 0.7235 | 0.6746 | 0.6468 | 0.6466 | 0.6211 |
| CSIQ | SROC | 0.8756 | 0.9133 | 0.7671 | 0.9195 | 0.8106 | 0.9466 | 0.9108 | 0.9295 | 0.9310 | 0.9423 | 0.9615 |
| | KROC | 0.6907 | 0.7393 | 0.5897 | 0.7537 | 0.6247 | 0.7970 | 0.7374 | 0.7645 | 0.7690 | 0.7857 | 0.8260 |
| | PLCC | 0.8613 | 0.8991 | 0.8384 | 0.9277 | 0.8002 | 0.9502 | 0.8964 | 0.9179 | 0.9192 | 0.9279 | 0.9614 |
| | RMSE | 0.1344 | 0.1149 | 0.1431 | 0.0980 | 0.1575 | 0.0818 | 0.1164 | 0.1042 | 0.1034 | 0.0979 | 0.0722 |
| LIVE | SROC | 0.9479 | 0.9513 | 0.9259 | 0.9636 | 0.9274 | 0.9669 | 0.9561 | 0.9401 | 0.9645 | 0.9524 | 0.9578 |
| | KROC | 0.7963 | 0.8045 | 0.7579 | 0.8282 | 0.7616 | 0.8421 | 0.8150 | 0.7816 | 0.8363 | 0.8058 | 0.8199 |
| | PLCC | 0.9449 | 0.9489 | 0.9268 | 0.9604 | 0.9231 | 0.9675 | 0.9512 | 0.9354 | 0.9613 | 0.9482 | 0.9543 |
| | RMSE | 8.9455 | 8.6188 | 10.264 | 7.6137 | 10.506 | 6.9073 | 8.4327 | 9.6642 | 7.5296 | 8.6816 | 8.1691 |

TABLE 3
SROCC evaluation values of 11 image quality evaluation methods on special distortions

| | Distortion | | MS- | | | | | | | | | |
|---|---|---|---|---|---|---|---|---|---|---|---|---|
| | type | SSIM | SSIM | IFC | VIF | VSNR | MAD | GSM | RFSM | FSIMc | VSI | MFS |
| TID | AGN | 0.8671 | 0.8646 | 0.6612 | 0.8994 | 0.8271 | 0.8843 | 0.9064 | 0.8878 | 0.9101 | 0.9460 | 0.9053 |
| 2013 | ANC | 0.7726 | 0.7730 | 0.5352 | 0.8299 | 0.7305 | 0.8019 | 0.8175 | 0.8476 | 0.8537 | 0.8705 | 0.8273 |
| | SCN | 0.8515 | 0.8544 | 0.6601 | 0.8835 | 0.8013 | 0.8911 | 0.9158 | 0.8825 | 0.8900 | 0.9367 | 0.9001 |
| | MN | 0.7767 | 0.8073 | 0.6932 | 0.8450 | 0.7072 | 0.7380 | 0.7293 | 0.8368 | 0.8094 | 0.7697 | 0.8186 |
| | HFN | 0.8634 | 0.8604 | 0.7406 | 0.8972 | 0.8455 | 0.8876 | 0.8869 | 0.9145 | 0.9040 | 0.9200 | 0.9063 |
| | IN | 0.7503 | 0.7629 | 0.6408 | 0.8537 | 0.7363 | 0.2769 | 0.7965 | 0.9062 | 0.8251 | 0.8741 | 0.8313 |
| | QN | 0.8657 | 0.8706 | 0.6282 | 0.7854 | 0.8357 | 0.8514 | 0.8841 | 0.8968 | 0.8807 | 0.8748 | 0.8421 |
| | GB | 0.9668 | 0.9673 | 0.8907 | 0.9650 | 0.9470 | 0.9319 | 0.9689 | 0.9698 | 0.9551 | 0.9612 | 0.9553 |
| | DEN | 0.9254 | 0.9268 | 0.7779 | 0.8911 | 0.9081 | 0.9252 | 0.9432 | 0.9359 | 0.9330 | 0.9484 | 0.9178 |
| | JPEG | 0.9200 | 0.9265 | 0.8357 | 0.9192 | 0.9008 | 0.9217 | 0.9284 | 0.9398 | 0.9339 | 0.9541 | 0.9377 |
| | JP2K | 0.9468 | 0.9504 | 0.9078 | 0.9516 | 0.9273 | 0.9511 | 0.9602 | 0.9518 | 0.9589 | 0.9706 | 0.9633 |
| | JGTE | 0.8493 | 0.8475 | 0.7425 | 0.8409 | 0.7908 | 0.8283 | 0.8512 | 0.8312 | 0.8610 | 0.9216 | 0.8885 |
| | J2TE | 0.8828 | 0.8889 | 0.7769 | 0.8761 | 0.8407 | 0.8788 | 0.9182 | 0.9061 | 0.8919 | 0.9228 | 0.9081 |
| | NEPN | 0.7821 | 0.7968 | 0.5737 | 0.7720 | 0.6653 | 0.8315 | 0.8130 | 0.7705 | 0.7937 | 0.8060 | 0.7727 |
| | Block | 0.5720 | 0.4801 | 0.2414 | 0.5306 | 0.1771 | 0.2812 | 0.6418 | 0.0339 | 0.5532 | 0.1713 | 0.1755 |
| | MS | 0.7752 | 0.7906 | 0.5522 | 0.6276 | 0.4871 | 0.6450 | 0.7875 | 0.5547 | 0.7487 | 0.7700 | 0.6285 |
| | CTC | 0.3775 | 0.4634 | 0.1798 | 0.8386 | 0.3320 | 0.1972 | 0.4857 | 0.3989 | 0.4679 | 0.4754 | 0.4598 |
| | CCS | 0.4141 | 0.4099 | 0.4029 | 0.3099 | 0.3677 | 0.0575 | 0.3578 | 0.0204 | 0.8359 | 0.8100 | 0.8102 |
| | MGN | 0.7803 | 0.7786 | 0.6143 | 0.8468 | 0.7644 | 0.8409 | 0.8348 | 0.8464 | 0.8569 | 0.9117 | 0.8630 |
| | CN | 0.8566 | 0.8528 | 0.8160 | 0.8946 | 0.8683 | 0.9064 | 0.9124 | 0.8917 | 0.9135 | 0.9243 | 0.9052 |
| | LCNI | 0.9057 | 0.9068 | 0.8180 | 0.9204 | 0.8821 | 0.9443 | 0.9563 | 0.9010 | 0.9485 | 0.9564 | 0.9290 |
| | ICQD | 0.8542 | 0.8555 | 0.6006 | 0.8414 | 0.8667 | 0.8745 | 0.8973 | 0.8959 | 0.8815 | 0.8839 | 0.9072 |
| | CHA | 0.8775 | 0.8784 | 0.8210 | 0.8848 | 0.8645 | 0.8310 | 0.8823 | 0.8990 | 0.8925 | 0.8906 | 0.8798 |
| | SSR | 0.9461 | 0.9483 | 0.8885 | 0.9353 | 0.9339 | 0.9567 | 0.9668 | 0.9326 | 0.9576 | 0.9628 | 0.9478 |
| TID | AGN | 0.8107 | 0.8086 | 0.5806 | 0.8797 | 0.7728 | 0.8386 | 0.8606 | 0.8415 | 0.8758 | 0.9229 | 0.8887 |
| 2008 | ANC | 0.8029 | 0.8054 | 0.5460 | 0.8757 | 0.7793 | 0.8255 | 0.8091 | 0.8613 | 0.8931 | 0.9118 | 0.8789 |
| | SCN | 0.8144 | 0.8209 | 0.5958 | 0.8698 | 0.7665 | 0.8678 | 0.8941 | 0.8468 | 0.8711 | 0.9296 | 0.8951 |
| | MN | 0.7795 | 0.8107 | 0.6732 | 0.8683 | 0.7295 | 0.7336 | 0.7452 | 0.8534 | 0.8264 | 0.7734 | 0.8375 |
| | HFN | 0.8729 | 0.8694 | 0.7318 | 0.9075 | 0.8811 | 0.8864 | 0.8945 | 0.9182 | 0.9156 | 0.9253 | 0.9225 |
| | IN | 0.6732 | 0.6907 | 0.5345 | 0.8327 | 0.6471 | 0.0650 | 0.7235 | 0.8806 | 0.7719 | 0.8298 | 0.7919 |
| | QN | 0.8531 | 0.8589 | 0.5857 | 0.7970 | 0.8270 | 0.8160 | 0.8800 | 0.8880 | 0.8726 | 0.8731 | 0.8500 |
| | GB | 0.9544 | 0.9563 | 0.8559 | 0.9540 | 0.9330 | 0.9196 | 0.9600 | 0.9409 | 0.9472 | 0.9529 | 0.9501 |
| | DEN | 0.9530 | 0.9582 | 0.7973 | 0.9161 | 0.9286 | 0.9433 | 0.9725 | 0.9400 | 0.9618 | 0.9693 | 0.9488 |
| | JPEG | 0.9252 | 0.9322 | 0.8180 | 0.9168 | 0.9174 | 0.9275 | 0.9393 | 0.9385 | 0.9294 | 0.9616 | 0.9416 |
| | JP2K | 0.9625 | 0.9700 | 0.9437 | 0.9709 | 0.9515 | 0.9707 | 0.9758 | 0.9488 | 0.9780 | 0.9848 | 0.9825 |
| | JGTE | 0.8678 | 0.8681 | 0.7909 | 0.8585 | 0.8055 | 0.8661 | 0.8790 | 0.8503 | 0.8756 | 0.9160 | 0.8706 |
| | J2TE | 0.8577 | 0.8606 | 0.7301 | 0.8501 | 0.7909 | 0.8394 | 0.8936 | 0.8592 | 0.8555 | 0.8942 | 0.8947 |
| | NEPN | 0.7107 | 0.7377 | 0.8418 | 0.7619 | 0.5716 | 0.8287 | 0.7386 | 0.7274 | 0.7514 | 0.7699 | 0.7094 |
| | Block | 0.8462 | 0.7546 | 0.6770 | 0.8324 | 0.1926 | 0.7970 | 0.8862 | 0.6258 | 0.8464 | 0.6295 | 0.4698 |
| | MS | 0.7231 | 0.7336 | 0.4250 | 0.5096 | 0.3715 | 0.5163 | 0.7190 | 0.4178 | 0.6554 | 0.6714 | 0.4810 |
| | CTC | 0.5246 | 0.6381 | 0.1713 | 0.8188 | 0.4239 | 0.2723 | 0.6691 | 0.5823 | 0.6510 | 0.6557 | 0.6348 |
| CSIQ | AGWN | 0.8974 | 0.9471 | 0.8431 | 0.9575 | 0.9241 | 0.9541 | 0.9440 | 0.9441 | 0.9359 | 0.9636 | 0.9647 |
| | JPEG | 0.9546 | 0.9634 | 0.9412 | 0.9705 | 0.9036 | 0.9615 | 0.9632 | 0.9502 | 0.9664 | 0.9618 | 0.9548 |
| | JP2K | 0.9606 | 0.9683 | 0.9252 | 0.9672 | 0.9480 | 0.9752 | 0.9648 | 0.9643 | 0.9704 | 0.9694 | 0.9750 |
| | AGPN | 0.8922 | 0.9331 | 0.8261 | 0.9511 | 0.9084 | 0.9570 | 0.9387 | 0.9357 | 0.9370 | 0.9638 | 0.9607 |
| | GB | 0.9609 | 0.9711 | 0.9527 | 0.9745 | 0.9446 | 0.9602 | 0.9589 | 0.9634 | 0.9729 | 0.9679 | 0.9758 |
| | GCD | 0.7922 | 0.9526 | 0.4873 | 0.9345 | 0.8700 | 0.9207 | 0.9354 | 0.9527 | 0.9438 | 0.9504 | 0.9485 |
| LIVE | JP2K | 0.9614 | 0.9627 | 0.9113 | 0.9696 | 0.9551 | 0.9676 | 0.9700 | 0.9323 | 0.9724 | 0.9604 | 0.9645 |
| | JPEG | 0.9764 | 0.9815 | 0.9468 | 0.9846 | 0.9657 | 0.9764 | 0.9778 | 0.9584 | 0.9840 | 0.9761 | 0.9759 |
| | AGWN | 0.9694 | 0.9733 | 0.9382 | 0.9858 | 0.9785 | 0.9844 | 0.9774 | 0.9799 | 0.9716 | 0.9835 | 0.9868 |
| | GB | 0.9517 | 0.9542 | 0.9584 | 0.9728 | 0.9413 | 0.9465 | 0.9518 | 0.9066 | 0.9708 | 0.9527 | 0.9622 |
| | FF | 0.9556 | 0.9471 | 0.9629 | 0.9650 | 0.9027 | 0.9569 | 0.9402 | 0.9237 | 0.9519 | 0.9430 | 0.9418 |

Experiment 2: Verify Time Complexity of the Method Disclosed by the Present Invention

Table 4 shows operation times while 11 image quality evaluation methods process a pair of 384×512 (selected from TID 2013 image library) color images. The experiment is done on LENOVO desktop computer, wherein a processor is Intel(R) core™ i5-4590, CPU is 3.3 GHz, a memory is 8G, a software platform is Matlab R2014b. It can be seen from Table 4 that the method disclosed by the present invention has a compromised time complexity, and especially, the method disclosed by the present invention has faster running speed than IFC algorithm, VIF algorithm, MAD algorithm and FSIMc algorithm, and obtains approximate or even better evaluation effects.

TABLE 4
Time complexities of 11 image quality evaluation methods

| Image quality evaluation algorithm | Time complexity (ms) |
|---|---|
| SSIM | 17.3 |
| MS-SSIM | 71.2 |
| IFC | 538.0 |
| VIF | 546.4 |
| VSNR | 23.9 |
| MAD | 702.3 |
| GSM | 17.7 |
| RFSM | 49.8 |
| FSIMc | 142.5 |
| VSI | 105.2 |
| MFS | 140.7 |

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. An image quality objective evaluation method based on manifold feature similarity comprising steps of:
(1) selecting a plurality of undistorted natural scene images; and then dividing every undistorted natural scene image into non-overlapping image blocks, each of which having a size of 8×8; and then randomly selecting N image blocks from all image blocks of all undistorted natural scene images, taking every selected image block as a training sample, recording a i^{th} training sample as Xᵢ, wherein 5000≦N≦20000, 1≦i≦N; and then arranging color values of R, G and B channels of all pixel points in every training sample for forming a color vector, recording the color vector formed by arranging color values of R, G and B channels of all pixel points in Xᵢ as Xᵢ^{col}, wherein a dimension of Xᵢ^{col} is 192×1, values from a 1^{st} element to a 64^{th} element in Xᵢ^{col} are respectively corresponding to color values of the R channel of every pixel point in Xᵢ obtained by a way of progressive scanning, values from a 65^{th} element to a 128^{th} element in Xᵢ^{col} are respectively corresponding to color values of the G channel of every pixel point in Xₜ obtained by a way of progressive scanning, values from a 129^{th} element to a 192^{nd} element in Xᵢ^{col} are respectively corresponding to color values of the B channel of every pixel point in X obtained by a way of progressive scanning; and then subtracting an average value of the values of all elements in a corresponding color vector from a value of every element in the corresponding color vector in every training sample, so as to centralizedly treat the corresponding color vector in every training sample, recording the centralizedly treated color vector in Xᵢ^{col} as \hat{x}ᵢ^{col}; and finally recording a matrix formed by all centralizedly treated color vectors as X, here X=[\hat{x}₁^{col}, \hat{x}₂^{col}, . . . , \hat{x}_{N}^{col}], wherein a dimension of X is 192×N, \hat{x}₁^{col}, \hat{x}₂^{col}, . . . , \hat{x}_{N}^{col} , respectively represent a centralizedly treated color vector of color values of R, G and B channels of all pixel points in a 1^{st} training sample, a centralizedly treated color vector of color values of R, G and B channels of all pixel points in a 2^{nd} training sample, . . . , and a centralizedly treated color vector of color values of R, G and B channels of all pixel points in a N^{th} training sample, and a symbol “[ ]” is a vector representation symbol;
(2) reducing the dimension of X and whitening X by a principal components analysis (PCA), recording a dimensional reduced and whitened matrix as X^{W}, wherein a dimension of X^{W} is M×N, M is a preset low-dimensional dimension, 1<M<192;
(3) training N column vectors in X^{W} by an existing orthogonal locality preserving projection (OLPP) algorithm for obtaining a best mapping matrix J^{W} of 8 orthogonal bases in X^{W}, wherein a dimension of J^{W} is 8×M; and then calculating a best mapping matrix of the original sample space according to J^{W} and the whitening matrix, recording the best mapping matrix of the original sample space as J, J=J^{W}×W, wherein a dimension of J is 8×192, W represents the whitening matrix, a dimension of W is M×192;
(4) regarding I_{org} as an original undistorted natural scene image, regarding I_{dis} as a distorted image of I_{org}, regarding I_{dis} as a distorted image to be evaluated; and then respectively dividing I_{org} and I_{dis} into non-overlapping image blocks, each of which having a size of 8×8, recording a i^{th} image block in I_{org} as xⱼ^{ref}, recording a j^{th} image block in I_{dis} as xⱼ^{dis}, wherein 1≦j≦N′, N′ represents an amount of the image blocks in I_{org}, and also represents an amount of the image blocks in I_{dis}; and then arranging color values of R, G and B channels of all pixel points of every image block in I_{org} for forming a color vector, recording the color vector formed by the color values of the R, G and B channels of all pixel points in xⱼ^{ref} as xⱼ^{ref,col}, arranging color values of R, G and B channels of all pixel points of every image block in I_{dis} for forming a color vector, recording the color vector formed by the color values of the R, G and B channels of all pixel points in xⱼ^{dis} as xⱼ^{dis,col}, wherein a dimension of xⱼ^{ref,col} is 192×1, values from a 1^{st} element to a 64^{th} element in xⱼ^{ref,col} are respectively corresponding to color values of the R channel of every pixel point in xⱼ^{ref} obtained by a way of progressive scanning, values from a 65^{th} element to a 128^{th} element in xⱼ^{ref,col} are respectively corresponding to color values of the G channel of every pixel point in xⱼ^{ref} obtained by a way of progressive scanning, values from a 129^{th} element to a 192^{nd} element in xⱼ^{ref,col} are respectively corresponding to color values of the B channel of every pixel point in x₇^{ref} obtained by a way of progressive scanning; values from a 1^{st} element to a 64^{th} element in xⱼ^{dis,col} are respectively corresponding to color values of the R channel of every pixel point in xⱼ^{dis} obtained by a way of progressive scanning, values from a 65^{th} element to a 128^{th} element in xⱼ^{dis,col} are respectively corresponding to color values of the G channel of every pixel point in xⱼ^{dis} obtained by a way of progressive scanning, values from a 129^{th} element to a 192^{nd} element in xⱼ^{dis,col} are respectively corresponding to color values of the B channel of every pixel point in xⱼ^{dis} obtained by a way of progressive scanning; and then subtracting an average value of the values of all elements in a corresponding color vector from a value of every element in the corresponding color vector of every image block in I_{org}, so as to centralizedly treat the corresponding color vector of every image block in I_{org}, recording the centralizedly treated color vector in xⱼ^{ref,col} as \hat{x}ⱼ^{ref,col}, subtracting an average value of the values of all elements in a corresponding color vector from a value of every element in the corresponding color vector of every image block in I_{dis}, so as to centralizedly treat the corresponding color vector of every image block in I_{dis}, recording the centralizedly treated color vector in xⱼ^{dis,col} as \hat{x}ⱼ^{dis,col}; and finally recording a matrix formed by all centralizedly treated color vectors in I_{org} as X^{ref}, here x^{ref}=[\hat{x}₁^{ref,col}, \hat{x}₂^{ref,col}, . . . , \hat{x}_{N′}^{ref,col}], recording a matrix formed by all centralizedly treated color vectors in I_{dis} as X^{dis} here X^{dis}=[\hat{x}₁^{dis,col}, \hat{x}₂^{dis,col}, . . . , \hat{x}_{N′}^{dis,col}], wherein a dimension of X^{ref} and X^{dis} is 192×N′, \hat{x}₁^{ref,col}, \hat{x}₂^{ref,col}, . . . , \hat{x}_{N′}^{ref,col} respectively represent a centralizedly treated color vector of color values of R, G and B channels of all pixel points of a 1^{st} image block in I_{org}, a centralizedly treated color vector of color values of R, G and B channels of all pixel points in a 2^{nd} image block in I_{org}, . . . , and a centralizedly treated color vector of color values of R, G and B channels of all pixel points in a (N)^{th} image block in I_{org}; \hat{x}₁^{dis,col}, \hat{x}₂^{dis,col}, . . . , \hat{x}_{N′}^{dis,col} respectively represent a centralizedly treated color vector of color values of R, G and B channels of all pixel points of a 1^{st} image block in I_{dis}, a centralizedly treated color vector of color values of R, G and B channels of all pixel points in a 2^{nd} image block in I_{dis}, . . . , and a centralizedly treated color vector of color values of R, G and B channels of all pixel points in a (N′)^{th} image block in I_{dis}; and a symbol “[ ]” is a vector representation symbol;
(5) calculating structural differences between every column vector in X^{ref} and a corresponding column vector in X^{dis}, recording the structural differences between \hat{x}ⱼ^{ref,col} and \hat{x}ⱼ^{dis,col} as AVE(\hat{x}ⱼ^{ref,col}, \hat{x}ⱼ^{dis,col});
and then arranging the obtained N′ structural differences in sequence for forming a vector with a dimension of 1×N′, recording the vector as v, wherein a value of a j^{th} element is vⱼ, here, vⱼ=AVE(\hat{x}ⱼ^{ref,col}, \hat{x}ⱼ^{dis,col});
and then obtaining a roughing selection undistorted image block set and a roughing selection distorted image block set, which specifically comprises steps of: (A) designing an image block roughing selection threshold; (B) extracting elements whose values are larger than or equal to TH₁ from v; and (C) taking a set formed by image blocks corresponding to the extracted elements in I_{org} as the roughing selection undistorted image block set, recording the roughing selection undistorted image block set as Y^{ref}, here, Y^{ref}={xⱼ^{ref}|AVE(\hat{x}ⱼ^{ref,col}, \hat{x}ⱼ^{dis,col})≧TH₁, 1≦j≦N′}; taking a set formed by image blocks corresponding to the extracted elements in I_{dis} as the roughing selection distorted image block set, recording the roughing selection distorted image block set as Y^{dis}, here, Y^{dis}={xⱼ^{dis}|AVE(\hat{x}ⱼ^{ref,col}, \hat{x}ⱼ^{dis,col})≧TH₁, 1≦j≦N′};
and then obtaining a fine selection undistorted image block set and a fine selection distorted image block set, which specifically comprises steps of: (a) respectively calculating saliency maps of I_{org} and I_{dis} using saliency detection based-on simple priors (SDSP) and recording as f^{ref} and f^{dis}; (b) respectively dividing f^{ref} and f^{dis} into non-overlapping image blocks, each of which having a size of 8×8; (c) calculating an average value of pixel values of all pixel points of every image block in f^{ref}, recording an average value of pixel values of all pixel points of a j^{th} image block in f^{ref} as vsⱼ^{ref}; calculating an average value of pixel values of all pixel points of every image block in f^{dis}, recording an average value of pixel values of all pixel points of a j^{th} image block in f^{dis} as vsⱼ^{dis}, wherein 1≦j≦N′; (d) obtaining a maximum value between the average value of pixel values of all pixel points of every image block in f^{ref} and the average value of pixel values of all pixel points of every image block in f^{dis} recording a maximum value between vsⱼ^{ref} and vsⱼ^{dis} as vs_{j,max}, here, vs_{j,max}=max(vsⱼ^{ref}, vsⱼ^{dis}), wherein max( ) is a maximum value function; and (e) finely selecting partial images from the roughing selection undistorted image block set as fine selection undistorted image blocks for forming a fine selection undistorted image block set, recording the fine selection undistorted image block set as Y^{%ref}, here, Y^{%ref}={xⱼ^{ref}|AVE(\hat{x}ⱼ^{ref,col}, \hat{x}ⱼ^{dis,col})≧TH₁ and vs_{j,max}≧TH₂, 1≦j≦N′}; finely selecting partial images from the roughing selection distorted image block set as fine selection distorted image blocks for forming a fine selection distorted image block set, recording the fine selection distorted image block set as Y^{%dis}, here, Y^{%dis}={xⱼ^{dis}|AVE(\hat{x}ⱼ^{ref,col}, \hat{x}ⱼ^{dis,col})≧TH₁and vs_{j,max}≧TH₂, 1≦j≦N′}, wherein TH₂ is a designed image block fine selection threshold;
(6) calculating manifold feature vectors of every image block in the fine selection undistorted image block set, recording a t^{th} manifold feature vector in the fine selection undistorted image block set as rₜ , here, rₜ=J×\hat{x}ⱼ^{ref,col}; calculating manifold feature vectors of every image block in the fine selection distorted image block set, recording a t^{th} manifold feature vector in the fine selection distorted image block set as dₜ, here, dₜ=J×\hat{x}ₜ^{dis,col}, wherein 1≦t≦K , K represents an amount of image blocks in the fine selection undistorted image block set and also represents an amount of image blocks in the fine selection distorted image block set, a dimension of rₜ and dₜ is 8×1, \hat{x}ₜ^{ref,col} represents a centralizedly treated color vector of color values of R, G and B channels of all pixel points in a t^{th} image block of the fine selection undistorted image block set, and \hat{x}ₜ^{dis,col} represents a centralizedly treated color vector of color values of R, G and B channels of all pixel points in a t^{th} image block of the fine selection distorted image block set;
and then defining manifold feature vectors of all image blocks in the fine selection undistorted image block set as a matrix, recording the matrix as R; defining manifold feature vectors of all image blocks in the fine selection distorted image block set as a matrix, recording the matrix as D, wherein a dimension of R and D is 8×K , a t^{th} column vector in R is rₜ, a t^{th} column vector in D is dₜ;
and then calculating manifold feature similarities of I_{org}, and I_{dis}, recording the manifold feature similarities as MFS₁, here,
$${MFS}_{1} = \frac{1}{8 \times K} {\sum }_{m = 1}^{8} {\sum }_{t = 1}^{K} \frac{2 {R}_{m , t} {D}_{m , t} + {C}_{1}}{{( {R}_{m , t} )}^{2} + {( {D}_{m , t} )}^{2} + {C}_{1}} ,$$
wherein R_{m,t} represents a value of M^{th} row and t^{th} column in R, D_{m,t} represents a value of M^{th} row and t^{th} column in D, C₁ is a very small constant for ensuring a result stability;
(7) calculating brightness similarities of I_{org} and I_{dis}, recording the brightness similarities as MFS₂, here,
$${MFS}_{2} = \frac{{\sum }_{t = 1}^{K} ( {μ}_{t}^{ref} - {\overline{μ}}^{ref} ) \times ( {μ}_{t}^{dis} - {\overline{μ}}^{dis} ) + {C}_{2}}{\sqrt{{\sum }_{t = 1}^{K} {( {μ}_{t}^{ref} - {\overline{μ}}^{ref} )}^{2} \times {\sum }_{t = 1}^{K} {( {μ}_{t}^{dis} - {\overline{μ}}^{dis} )}^{2} + {C}_{2 }}} ,$$
wherein μₜ^{ref} represents an average value of brightness values of all pixel points in a t^{th} image block in the fine selection undistorted image block set,
$${\overline{μ}}^{ref} = \frac{{\sum }_{t = 1}^{K} {μ}_{t}^{ref}}{K} ;$$
μₜ^{dis} represents an average value of brightness values of all pixel points in a t^{th} image block in the fine selection distorted image block set,
$${\overline{μ}}^{dis} = \frac{{\sum }_{t = 1}^{K} {μ}_{t}^{dis}}{K} ,$$
C₂ is a very small constant; and
(8) linearly weighting MFS₁ and MFS₂ for obtaining mass fractions of I_{dis}, recording the mass fractions as MFS, here, MFS=ω×MFS₂+(1−ω)×MFS₁, wherein ω is adapted for adjusting a relative importance of MFS₁ and MFS₂, 0<ω<1.

2. The image quality objective evaluation method based on manifold feature similarity, as recited in claim 1, wherein in step (2), an acquisition method of X^{W} comprises steps of:
(2A) calculating a covariance matrix of X and recording the covariance matrix as C,
$$C = \frac{1}{N} ( X \times {X}^{T} ) ,$$
wherein a dimension of C is 192×192, X^{T} is a transposed matrix of X;
(2B) eigenvalue-decomposing C based on prior art for obtaining an eigenvalue diagonal matrix and an eigenvector matrix, respectively recording the eigenvalue diagonal matrix and the eigenvector matrix as ψ and E, wherein a dimension of ψ is 192×192,
$$ψ = [ \begin{matrix}{ψ}_{1} & 0 & … & 0 \\ 0 & {ψ}_{2} & … & 0 \\ M & M & M & M \\ 0 & 0 & … & {ψ}_{192}\end{matrix} ] ,$$
ψ₁, ψ₂ and ψ₁₉₂ respectively represent a 1^{st} eigenvalue, a 2^{nd} eigenvalue and a 192^{nd} eigenvalue after decomposition, a dimension of E is 192×192, E=[e₁ e₂ e₁₉₂], e₁, e₂ and e₁₉₂ respectively represent a 1^{st} eigenvector, a 2^{nd} eigenvector and a 192^{nd} eigenvector after decomposition, a dimension of e₁, e₂ and e₁₉₂ is 192×1;
(2C) calculating a whitening matrix and recording the whitening matrix as W, W=ψ_{M×192}^{-1/2}×E^{T}, wherein a dimension of W is M×192,
$${ψ}_{M \times 192}^{- \frac{1}{2}} = [ \begin{matrix}1 / \sqrt{{ψ}_{1}} & 0 & … & 0 & … & 0 \\ 0 & 1 / \sqrt{{ψ}_{2}} & … & 0 & … & 0 \\ M & M & M & M & M & M \\ 0 & 0 & … & 1 / \sqrt{{ψ}_{M}} & … & 0\end{matrix} ] ,$$
ψ_{M} represents a M^{th} eigenvalue after decomposition, M is a preset low-dimensional dimension, 1<M<192, E^{T} is a transposed matrix of E; and
(2D) calculating the dimension-reduced and whitened matrix X^{W} wherein X^{W}=W×X.

3. The image quality objective evaluation method based on manifold feature similarity, as recited in claim 1, wherein in the step (5),
$$AVE ( {\hat{x}}_{j}^{ref , col} , {\hat{x}}_{j}^{dis , col} ) = \vert {\sum }_{g = 1}^{192} {( {\hat{x}}_{j}^{ref , col} ( g ) )}^{2} - {\sum }_{g = 1}^{192} {( {\hat{x}}_{j}^{dis , col} ( g ) )}^{2} \vert ,$$
here, a symbol “| |” is an absolute value symbol, \hat{x}ⱼ^{ref,col} (g) represents a value of a g^{th} element in \hat{x}ⱼ^{ref,col}, \hat{x}ⱼ^{dis,col} (g) represents a value of a g^{th} element in \hat{x}ⱼ^{dis,col}.

4. The image quality objective evaluation method based on manifold feature similarity, as recited in claim 2, wherein in the step (5),
$$AVE ( {\hat{x}}_{j}^{ref , col} , {\hat{x}}_{j}^{dis , col} ) = \vert {\sum }_{g = 1}^{192} {( {\hat{x}}_{j}^{ref , col} ( g ) )}^{2} - {\sum }_{g = 1}^{192} {( {\hat{x}}_{j}^{dis , col} ( g ) )}^{2} \vert ,$$
here, a symbol “| |” is an absolute value symbol, \hat{x}ⱼ^{ref,col}(g) represents a value of a g^{th} element in \hat{x}ⱼ^{ref,col}, \hat{x}ⱼ^{dis,col}(g) represents a value of a g^{th} element in \hat{x}ⱼ^{dis,col}.

5. The image quality objective evaluation method based on manifold feature similarity, as recited in claim 3, wherein in the step (A) of the step (5), TH₁=median(v), here, median( ) is a median selection function, median(v) represents selecting a mid-value of values of all elements in v.

6. The image quality objective evaluation method based on manifold feature similarity, as recited in claim 4, wherein in the step (A) of the step (5), TH₁=median(v), here, median( ) is a median selection function, median(v) represents selecting a mid-value of values of all elements in v.

7. The image quality objective evaluation method based on manifold feature similarity, as recited in claim 3, wherein in the step (e) of the step (5), a value of TH₂ is a maximum value at a former 60% position after arranging all maximum values obtained in the step (d) from big to small.

8. The image quality objective evaluation method based on manifold feature similarity, as recited in claim 4, wherein in the step (e) of the step (5), a value of TH₂ is a maximum value at a former 60% position after arranging all maximum values obtained in the step (d) from big to small.
